(19) United States
(12) Patent Application Publication
(10) Pub. No.: US 2017/0008482 A1
(43) Pub. Date: Jan. 12, 2017

(54) GAS GENERATOR

(71) Applicant: DAICEL CORPORATION, Osaka-shi (JP)

(72) Inventors: Tomoharu KOBAYASHI, Tatsuno-shi (JP); Masayuki YAMAZAKI, Tatsuno-shi (JP); Kenji FUKUMOTO, Tatsuno-shi (JP)

(73) Assignee: DAICEL CORPORATION, Osaka-shi, Osaka (JP)

(21) Appl. No.: 15/113,363

(22) PCT Filed: Jan. 19, 2015
(86) PCT No.: PCT/JP2015/051164

§ 371 Date: Jul. 21, 2016

(30) Foreign Application Priority Data
Feb. 14, 2014 (JP) 2014-026065

(51) Int. Cl. B60R 21/264

(52) U.S. Cl. CPC B60R 21/264; B60R 2021/26029

(57) ABSTRACT

The present invention is to improve a method of rupturing a closing member for a pressurized gas filled chamber in a gas generator.

The gas generator according to the present invention has, in a cylindrical housing, a closing member closing between an ignition device chamber and a pressurized gas chamber, an igniter and a breaking device that are disposed in the ignition device chamber, and a rupturing portion of the breaking device having a base plate, which is provided with a plurality of through holes passing through in a thickness direction thereof, and a rod that extends in the axial direction from the base plate.

At least a tip portion of the rod is a polygonal column, and at time of actuation, the base plate and the rod move inside the guide portion, and the tip portion of the rod collides with the closing member to open the closing member.

### FIELD OF INVENTION

The present invention relates to a gas generator for use in an airbag apparatus to be installed in a vehicle.

### DESCRIPTION OF RELATED ART

In a gas generator using a pressurized gas as a gas source, a gas outlet of a pressurized gas chamber is closed with a closing member made of a stainless steel or the like. Therefore, a breaking device is needed for breaking the closing member and opening the gas outlet at the time of actuation.

In an inflator depicted in FIG. 1 of US-A No. 2009/0045612, FIG. 4 (Paragraph [0049]) discloses that a punch 54, which has a circular or quadrangular cross-section and a convex or concave tip end surface, ruptures and opens a burst disk 26 closing an outlet of a chamber 18 filled with a high-pressure gas.

In U.S. Pat. No. 5,582,426, as is obvious from the changing status shown in FIG. 1 to FIG. 3, at the time of actuation, a movable section 146, which is cut off from a frangible section 148 of the ignition cup 122, collides with a central portion of a closure 102, a combustion product, which is ejected from a vent opening 162, also collides with the central portion of the rupturable plate 102, and thereby the rupturable plate 102 deforms to expand in a gas-flow direction and opens.

### SUMMARY OF INVENTION

Invention 1 of the present invention provides a gas generator (10), including:

a cylindrical housing (11) including therein, an ignition device chamber (20) which accommodates an igniter (25) and is provided with a gas discharge port (22), and a pressurized gas chamber (50) filled with a pressurized gas;

a closing member (15) closing between the ignition device chamber (20) and the pressurized gas chamber (50);

in the ignition device chamber (20), the igniter (25) which has an igniter main body (26) and an igniter collar (27), and a breaking device (30) for the closing member (15),

the igniter (25) being fixed to an end portion of the cylindrical housing (11) on a side of the ignition device chamber (20),

the breaking device (30) for the closing member (15) having,
a cylindrical guide portion (31) formed inside the ignition device chamber (20), and
a rupturing portion (40) disposed to be movable in an axial direction inside the cylindrical guide portion (31),

the cylindrical guide portion (31) being disposed such that,
a first end portion (31a) thereof encloses an ignition portion of the igniter main body (26) and is fixed to the igniter collar (27) or an inner wall surface of the cylindrical housing (11), and a second end portion (31b) thereof on an opposite side to the first end portion is positioned on a side of the closing member (15),

the rupturing portion (40) having,
a base plate (41) including a pressure-receiving surface (41a) which receives a combustion product from the igniter (25), and a rod (42) extending in the axial direction from a surface (41b) of the base plate (41) on the reverse side of the pressure-receiving surface (41a),

the base plate (41) provided with a plurality of through holes (43) passing through in a thickness direction thereof,

at least a tip portion of the rod (42) being a polygonal column,

before actuation, the base plate (41) being disposed to abut against an inner circumferential surface (31c) of the cylindrical guide portion (31), and

at the time of actuation, the base plate (41) and the rod (42) being moved inside the guide portion (31) by the combustion product generated due to the igniter (25), and the tip portion of the rod (42) colliding with and opening the closing member (15), thereby opening a gas discharge path extending from the pressurized gas chamber (20) to the gas discharge port (22).

Invention 2 of the present invention provides a gas generator (100), including:

a cylindrical housing (11) including therein, an ignition device chamber (20) which accommodates an igniter (25) and is provided with a gas discharge port (22), and a pressurized gas chamber (50) filled with a pressurized gas;

a closing member (15) closing between the ignition device chamber (20) and the pressurized gas chamber (50);

in the ignition device chamber (20), the igniter (25) which has an igniter main body (26) and an igniter collar (27), and a breaking device (30) for the closing member (15),

the igniter (25) being fixed to an end portion of the cylindrical housing (11) on a side of the ignition device chamber (20),

the breaking device (30) for the closing member (15) having,
a cylindrical guide portion (131) formed inside the ignition device chamber (20), and
a rupturing portion (40) disposed to be movable in an axial direction inside the cylindrical guide portion (131),

the cylindrical guide portion (131) extending from a surface of the igniter collar (127), that faces an interior of the ignition device chamber (20), and enclosing the ignition portion of the igniter main body (126), and being open on a side of the closing member (15),

the rupturing portion (40) having,
a base plate (41) including a pressure-receiving surface which receives a combustion product from the igniter (125), and a rod (42) extending in the axial direction from a surface of the base plate (41) on the reverse side of the pressure-receiving surface,
the base plate (41) provided with a plurality of through holes (43) passing through in a thickness direction thereof,

at least a tip portion of the rod (42) being a polygonal column,

before actuation, the base plate (41) being disposed to abut against an inner circumferential surface of the cylindrical guide portion (131), and

at time of actuation, the base plate (41) and the rod (42) being moved inside the cylindrical guide portion (131) by the combustion product generated due to the igniter (25), and the tip portion of the rod (42) colliding with and opening the closing member (15), thereby opening a gas discharge path extending from the pressurized gas chamber (50) to the gas discharge port (22).

Invention 3 of the present invention provides a gas generator (200), including:

a cylindrical housing (11) including therein, an ignition device chamber (20) which accommodates an igniter (25) and is provided with a gas discharge port (22), and a pressurized gas chamber (50) filled with a pressurized gas;

a closing member (15) closing between the ignition device chamber (20) and the pressurized gas chamber (50);

in the ignition device chamber (20), the igniter (25) which has an igniter main body (26) and an igniter collar (27), and a breaking device (240) for the closing member (15),

the igniter (25) being fixed to an end portion of the cylindrical housing (11) on a side of the ignition device chamber (20),

the breaking device (240) for the closing member (15) being a rupturing portion (240) disposed to be movable in an axial direction inside the ignition device chamber (20),

the rupturing portion (240) having,
a base plate (241) including a pressure-receiving surface (241a) that receives a combustion product from the igniter (25), and a rod (242) extending in the axial direction from a surface (241b) of the base plate (241) on the reverse side of the pressure-receiving surface (241a),
the base plate (241) provided with a plurality of through holes (243) passing through in a thickness direction thereof,

at least a tip portion of the rod (242) being a polygonal column,

before actuation, the base plate (241) of the rupturing portion (240) being disposed to abut against an inner wall surface (21c) of the ignition device chamber (20), and

at time of actuation, the base plate (241) and the rod (242) being moved inside the ignition device chamber (20) by the combustion product generated due to the igniter (25), and the tip portion of the rod (242) colliding with and opening the closing member (15), thereby opening a gas discharge path extending from the pressurized gas chamber (50) to the gas discharge port (22).

### BRIEF DESCRIPTION OF THE DRAWINGS

The present invention will become more fully understood from the detailed description given hereinbelow and the accompanying drawings which are given by way of illustration only, and thus are no limitative of the present invention and wherein:

FIG. 1 is a sectional view, in the X-axis direction, of a gas generator in accordance with the present invention;

FIG. 2 is an axial sectional view illustrating a housing of another embodiment of that in the gas generator depicted in FIG. 1;

FIG. 3 is an axial sectional view illustrating a housing of still another embodiment of that in the gas generator depicted in FIG. 1;

FIG. 4 is a partial sectional view of a breaking device in the gas generator depicted in FIG. 1;

FIG. 5 is, in (a), an axial sectional view of the breaking device in the gas generator depicted in FIG. 1 and, in (b), a plan view of the breaking device depicted in (a) in FIG. 5;

FIG. 6 is, in (a) and (b), an axial sectional view of a rupturing portion of another embodiment of that in the gas generator depicted in FIG. 1;

FIG. 7 is, in (a), an axial sectional view of a rupturing portion of still another embodiment of that in the gas generator depicted in FIG. 1, and, in (b), is a plan view of the rupturing portion depicted in (a) in FIG. 7;

FIG. 8 is, in (a), a sectional view, in an X-axis direction, of another embodiment of the gas generator depicted in FIG. 1 and, in (b), a partial sectional view, in the X-axis direction, of the gas generator with partial structure different from the gas generator depicted in (a) in FIG. 8; and

FIG. 9 is a sectional view, in the X-axis direction, of still another embodiment of the gas generator depicted in FIG. 1.

### DETAILED DESCRIPTION OF THE INVENTION

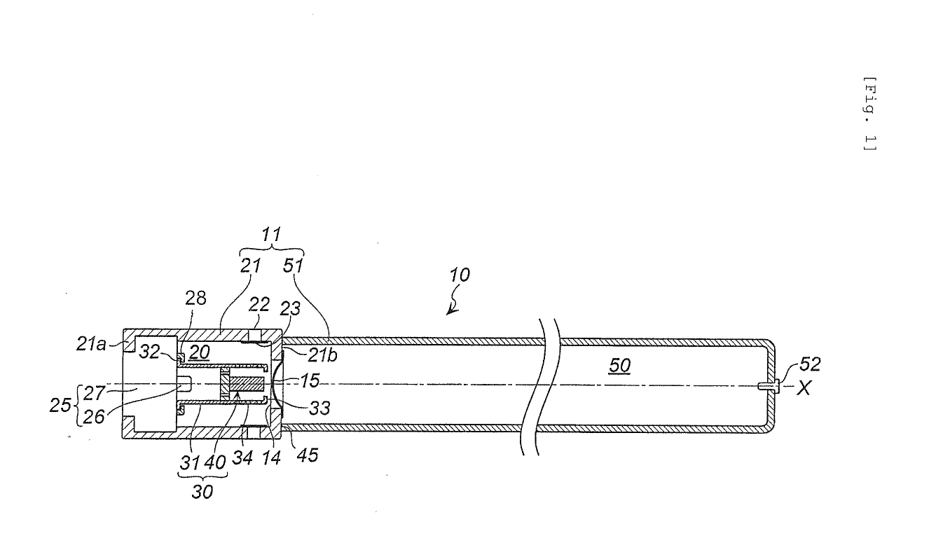

In the inflator depicted in FIG. 1 of US-A No. 2009/0045612, the rupturing is performed only by the punch 54 at the time of actuation, and a sufficient cross-sectional area for gas discharge sometimes cannot be ensured because the opening created by rupturing of the burst disk 26 is insufficient or the open state cannot be sufficiently maintained.

In FIG. 1 to FIG. 3 of U.S. Pat. No. 5,582,426, a force required for the rupturing is small because the closure 102 is ruptured from a high-pressure side.

However, in the gas generator depicted in FIG. 1, the tip of a movable section 146 is a curved surface and a vent opening 162 is provided to equalize the pressures inside an ignition cup 122 and inside a chamber 44. Furthermore, the cup 122 is made small to enable rapid increase in pressure therein at the time of actuation, and an end surface 162 of the movable section 146 is also a curved surface. Therefore, it can be assumed that the rupturable plate 102 is not easily ruptured.

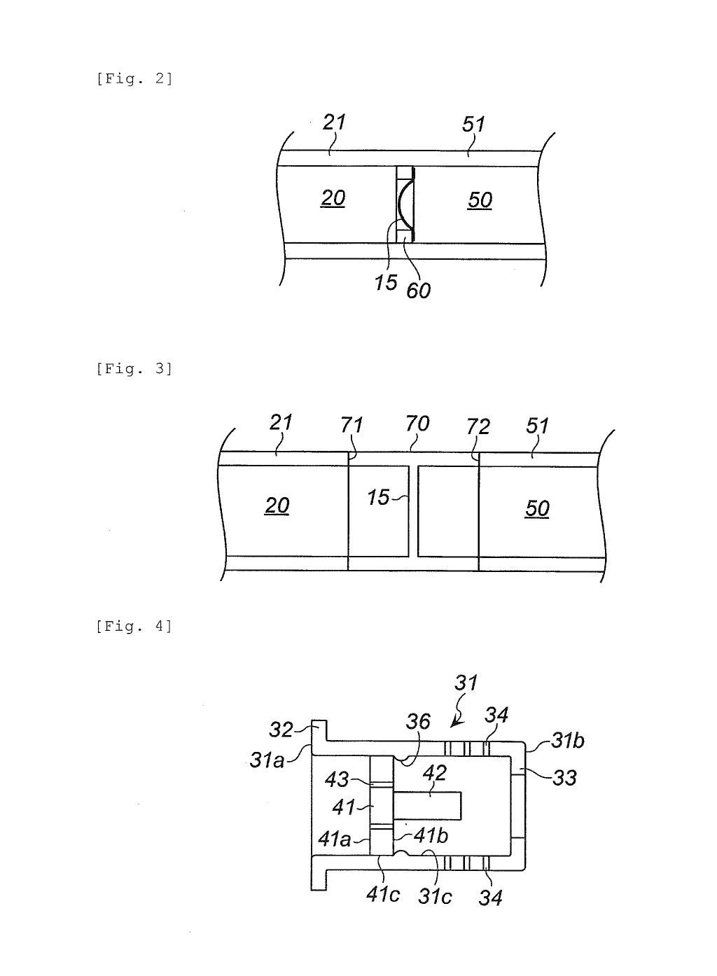

In the process of transition from the state depicted in FIG. 2 to that depicted in FIG. 3, a combustion product CP is released into a chamber 44 filled with a high-pressure gas and the pressure inside the chamber instantaneously rises. Therefore, the thickness of a metal tube 24 needs to be increased in order to increase pressure resistance.

Further, in the state depicted in FIG. 3, since the movable section 146 is not fixed, the gas flow channel may be narrowed depending on the position of the movable portion 146.

Therefore, in the invention disclosed in U.S. Pat. No. 5,582,426, there is still room for improvement in terms of weight reduction and operation reliability.

The present invention provides a gas generator, using a pressurized gas as a gas source, in which a method for rupturing the closing member closing the outlet of the chamber filled with the pressurized gas is improved.

In the gas generator of Invention 1, the gas discharge path extending from the pressurized gas chamber to the gas discharge port is opened by rupturing the closing member that closes the gas outlet of the pressurized gas chamber, with a rupturing method in combination with a combustion product, such as gas, flame or shock wave, generated by the operation of the igniter as an ignition device, and the breaking device having a guide portion and a rupturing portion.

A known gas generating agent can be used together with the igniter as the ignition device.

In the cylindrical guide portion, a first end portion on the side of the igniter encloses the ignition portion of the igniter main body and is fixed to the igniter collar or the inner wall surface of the cylindrical housing.

When the first end portion of the cylindrical guide portion is fixed to the igniter collar, a method of forming a flange at the first end portion of the cylindrical guide portion and fitting the flange in a groove formed at the surface of the igniter collar, a method of bending inward a protrusion formed on the surface of the igniter collar and pressing the protrusion to the flange portion, or a welding method may be employed.

When the first end portion of the cylindrical guide portion is fixed to the inner wall surface of the cylindrical housing (the inner wall surface of the ignition device chamber), a method of forming a flange at the first end portion of the cylindrical guide portion and press-inserting the end of the flange to the inner wall surface of the cylindrical housing may be employed. In this case, a method of fixing by forming an annular surface portion extending in the axial direction of the cylindrical housing from the circumferential edge of the flange formed at the first end portion of the cylindrical guide portion, and press-inserting the annular surface portion to the inner wall surface of the cylindrical housing, or a method of fixing by welding may also be employed. The first end portion may also be fixed to the collar or the housing by welding.

The cylindrical guide portion may also be fixed to the inner wall surface of the igniter collar or the cylindrical housing by using another member.

The second end portion on the other side of the cylindrical guide portion is arranged to be positioned on the side of the closing member.

The second end portion of the cylindrical guide portion is arranged such that a gap is formed between the second end portion and the closing member. The gap serves as part of the gas discharge path extending from the pressurized gas chamber to the gas discharge port.

The cylindrical guide portion may have an inward annular surface portion which is formed inwardly at an opening of the second end portion.

An inner diameter of the inward annular surface portion may be adjusted to be smaller than an outer diameter of the base plate of the rupturing portion so that the inward annular surface portion functions as a stopper for the rupturing portion moving in the axial direction at the time of actuation.

The cylindrical guide portion may have a plurality of release holes provided in the circumferential wall surface thereof.

The plurality of release holes functions to release, to the outside of the cylindrical guide portion, the combustion product remaining therein, after the closing member is ruptured at the time of actuation.

The rupturing portion has the base plate including the pressure-receiving surface (a first surface) that receives the combustion product from the igniter, and a rod extending in the axial direction from the surface (a second surface) of the base plate on the reverse side of the pressure-receiving surface.

The base plate has a plurality of through holes passing through in the thickness direction thereof. The plurality of through holes function to allow passage of the combustion product generated from the igniter and to make the combustion product collide with the closing member at the time of actuation.

At least a tip portion of the rod is configured in a polygonal column. The rod may be entirely configured in a polygonal column, or only the tip portion may be a polygonal column and a portion other than the tip portion may be in any shape except for an angular column (may be a round column).

Where a rod is used in which at least the tip portion is a polygonal column, the tip portion ruptures the closing member under a load lower than that required for a round columnar tip having the same cross-sectional area. The reason therefor is explained hereinbelow.

When the rod having a round columnar tip portion collides with the closing member, a round opening is formed in the closing member, and thereby the further rupturing is unlikely to advance.

By contrast, when the rod having an angular columnar tip portion collides with the closing member, an opening of the same polygonal shape is formed, and thereby stresses concentrate in the corners of the polygonal opening, and the rupturing is facilitated.

Therefore, as mentioned hereinabove, it is preferred that a rupturing portion provided with a rod having an angular columnar tip is used because the closing member is ruptured under a lower load.

In the rupturing portion before the actuation, the base plate is disposed to abut against the inner wall surface of the cylindrical guide portion.

In the rupturing portion, the central axis of the rod and the center of the closing member may or may not coincide with each other in the axial direction.

The plurality of through holes of the base plate in the rupturing portion may be formed equidistantly in a circumferential direction around the rod,

the plurality of through holes may be exactly opposite the closing member in the axial direction of the cylindrical housing, and

no other member may be disposed on the imaginary axial line connecting the closing member with at least any one of centers of the plurality of through holes.

With such an arrangement, when part of the combustion product generated from the igniter advances in the axial direction through the plurality of through holes, the advancing combustion product is unlikely to collide with another member along the way and large part thereof directly collides with the closing member. It is even more preferred that no other member be disposed even on the entire extension of the plurality of the through holes.

The combustion product thus advancing through the plurality of the through holes does not collide with the center of the closing member but collides off-center.

Therefore, since the rod collides with the center of the closing member and the combustion product collides off-center (radially outer side with respect to the rod), intense heat and a high load are together applied to a wide surface of the closing member including the center thereof, thereby facilitating the rupturing and opening of the closing member.

In particular, the central portion of the closing member is opened by the rod, the rupturing advances radially from the opened portion, and the ruptured closing member is bent toward the ignition device chamber by the pressure of the pressurized gas. Since the high-temperature gas after passing through the through holes collides with the periphery of the central portion of the closing member, the advancement of rupturing and the initiation of bending are facilitated and a surface area for discharging the pressurized gas is easily ensured.

The rod of the rupturing portion may have a flat tip surface or a concave tip surface, provided that at least the tip portion is a polygonal column. The concave surface may be a curved (spherical) surface or may include a plurality of planes (a plurality of triangular surfaces).

A cross-sectional shape of a portion at the polygonal column in the rod can be selected from triangular, quadrangular, pentagonal, and hexagonal shapes.

The plurality of through holes formed in the base plate in the rupturing portion may be closed with a sealing member attached from a first surface.

In the gas generator of Invention 2 according to the present invention, the cylindrical guide portion differs from that used in the gas generator of Invention 1 with respect to the guide portion that is integrated with the igniter collar. However, the advantageous effect is obtained similarly to the gas generator of Invention 1 according to the present invention.

The cylindrical guide portion may have an inward annular surface portion which is formed inwardly at an opening thereof.

An inner diameter of the inward annular surface portion may be adjusted to be smaller than an outer diameter of the base plate in the rupturing portion so that the inward annular surface portion functions as a stopper for the rupturing portion moving in the axial direction at the time of actuation.

The gas generator of Invention 3 according to the present invention is different from the gas generator of Invention 1 with respect to an absence of the cylindrical guide portion of the breaking device and with respect to functionality of the cylindrical guide portion on the inner wall surface of the igniter device chamber. However, the advantageous effect is obtained similarly to the gas generator of Invention 1 according to the present invention.

In the gas generator according to the present invention using a pressurized gas as a gas source, a method for rupturing the closing member that closes the outlet of the chamber filled with the pressurized gas is improved. Therefore, a rupturing ability for the closing member is improved.

### DESCRIPTION OF EMBODIMENTS

### (1) Gas Generator Depicted in FIG. 1

A gas generator 10 has an ignition device chamber 20 and a pressurized gas chamber 50 inside a cylindrical housing 11, the ignition device chamber accommodating an igniter 25 and having a gas discharge port 22, and the pressurized gas chamber being filled with a pressurized gas. Before actuation, the gas discharge port 22 is closed with a sealing tape 23.

The cylindrical housing 11 of the gas generator 10 depicted in FIG. 1 is formed by integrating and welding an ignition device chamber housing 21 forming the ignition device chamber 20 and a pressurized gas chamber housing 51 forming the pressurized gas chamber 50 at an annular connection portion 45.

The cylindrical housing 11 is made of a metal such as iron or stainless steel.

The interior of the pressurized gas chamber 50 is filled under a high pressure with a gas such as argon or helium. A closing member 15 made of a stainless steel, or the like, closes between the ignition device chamber 20 and the pressurized gas chamber 50 (a gas outlet 14 of the pressurized gas chamber 50). A gas filling hole of the pressurized gas chamber housing 51 is closed by welding together with a pin 52.

In FIG. 1, the closing member 15 is fixed by welding to an inward annular portion 21b of the ignition device chamber housing 21, but the closing member may be fixed by welding to the pressurized gas chamber housing 51.

At the time of assembling, the closing member 15 is a disk, but the closing member is deformed into a bowl-like shape by receiving the pressure from the pressurized gas chamber 50 after the assembling.

In the embodiment of the cylindrical housing 11 depicted in FIG. 1, the outer diameter of the ignition device chamber housing 21 is different from that of the pressurized gas chamber housing 51, but the embodiments depicted in FIGS. 2 and 3 can be implemented instead of such embodiment.

In FIG. 2, the cylindrical housing 11 (the ignition device chamber housing 21 and the pressurized gas chamber housing 51) is formed from a single cylindrical member.

A rupturable plate 15 is fixed by welding to an annular member 60.

At the time of assembling, before the igniter 25 is attached to the cylindrical housing 11, the annular member 60 to which the rupturable plate 15 is fixed by welding is inserted from an opening of the ignition device chamber housing 21 and fixed by laser welding or the like from an outside thereof.

FIG. 3 illustrates an embodiment using an adaptor member 70 equipped with the rupturable plate 15.

The ignition device chamber housing 21 and the adaptor member 70 are fixed by welding at a contact portion 71, and the pressurized gas chamber housing 51 and the adaptor member 70 are fixed by welding at a contact portion 72.

In FIG. 1, the igniter 25 having an igniter main body 26 and an igniter collar 27, and a breaking device 30 for the closing member 15 are disposed inside the ignition device chamber 20.

The igniter 25 is inserted from an opening at the end portion of the ignition device chamber 20 in the cylindrical housing 11 and fixed by bending inward the end portion 21a of the ignition device chamber housing 21.

In the gas generator 10 depicted in FIG. 1, a gas generating agent can be used together with the igniter 25. When the gas generating agent is used, the agent is charged in a space (a space inside a cylindrical guide portion 31, between the igniter main body 26 and a base plate 41 of a rupturing portion 40) that is in communication with the igniter main body 26.

The breaking device 30 has a cylindrical guide portion 31 disposed inside the ignition device chamber 20, and the rupturing portion 40 disposed to be movable in an axial direction inside the cylindrical guide portion 31.

The cylindrical guide portion 31 and the rupturing portion 40 can be formed of the material same as that of the cylindrical housing 11.

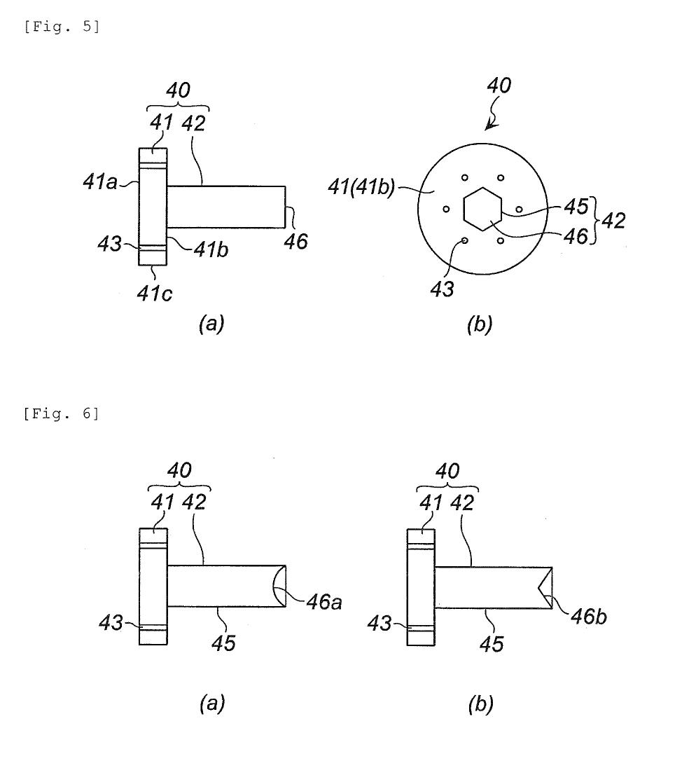

The cylindrical guide portion 31 depicted in FIG. 4 has a flange 32 on a first end portion 31a on the side of the igniter 25 and also has an inward annular surface portion 33 extending inward, which is in the reverse direction of the flange 32, at a second end portion 31b on the other side of the first end portion 31a.

A plurality of release holes (gas release holes) 34 are formed in a circumferential wall surface of the cylindrical guide portion 31.

The cylindrical guide portion 31 encloses the ignition portion of the igniter main body 26 at the first end portion 31a and is fixed such that the flange 32 abuts against the igniter collar 27 and a gap is present between the second end portion 31b and the rupturable plate 15.

The outer diameter of the cylindrical guide portion 31 is smaller than the inner diameter of a gas outlet 14 closed by the closing member 15.

In FIG. 1, the cylindrical guide portion 31 is fixed at the flange 32 by bending inward a protrusion 28 formed at the surface of the igniter collar 27, but another fixing method may be used.

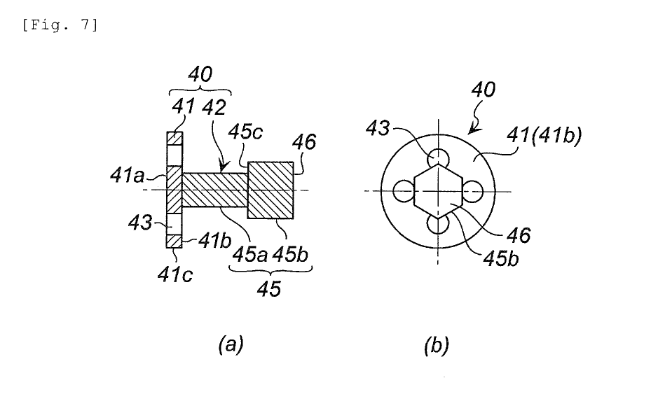

As depicted in (a) in FIG. 5, the rupturing portion 40 has the base plate 41 including a pressure-receiving surface (a first surface) 41a that receives a combustion product from the igniter 25, and a rod 42 extending in the axial direction from a second surface (the other surface) 41b on the reverse side of the pressure-receiving surface (a first surface) 41a of the base plate 41.

The base plate 41 has a plurality of the through holes 43 passing through in the thickness direction thereof.

As depicted in (b) in FIG. 5, the plurality of (six in (b) in FIG. 5) through holes 43 are formed equidistantly in the circumferential direction around the rod 42.

The closing member 15 is present on the extension of the whole through holes 43, and no other member is present between the holes and the closing member. Further, between the through holes 43 and the rupturable plate 15, there is nothing that hinders the collision of the gas after passing through the through holes 43 with the rupturable plate 15.

The number of the through holes 43 is preferably within a range of four to ten. In (b) in FIG. 5, the number of sides matches the number of the through holes 43, but the number of sides may not match the number of the through holes 43. Further, in (b) in FIG. 5, the through holes 43 are formed at positions facing the sides, but may be formed at positions facing the corners, or alternately or randomly at positions facing the sides and corners.

The plurality of the through holes 43 may be closed with a sealing member from the first surface 41a.

At least the tip of the rod 42 is a polygonal column.

In the rod 42 depicted in (a) and (b) in FIG. 5, the circumferential surface 45 is configured of a regular hexagonal column.

The rod 42 may be configured of a regular triangular column (the cross section is a regular triangle), a regular quadrangular column (the cross section is a square), or another polygonal column.

In the rod 42 of the rupturing portion 40 depicted in (a) and (b) in FIG. 5, a tip surface (a tip surface of the polygonal columnar portion) 46 is a flat surface, but the tip surface 46 may be a concave surface.

In (a) in FIG. 6, a tip surface 46a of the rod 42 is a concave surface configured of a spherical surface, and in (b) in FIG. 6, a tip surface 46b of the rod 42 is a concave surface including a plurality of faces in triangle.

In the case of the tip surface (the concave surface) 46b depicted in (b) in FIG. 6, when the rod 42 is of a regular hexagonal shape, the concave surface includes 6 faces in triangle, when the rod 42 is of a regular quadrangular shape, the concave surface includes 4 faces in triangle, and when the rod 42 is a regular triangular shape, the concave surface includes 3 faces in triangle.

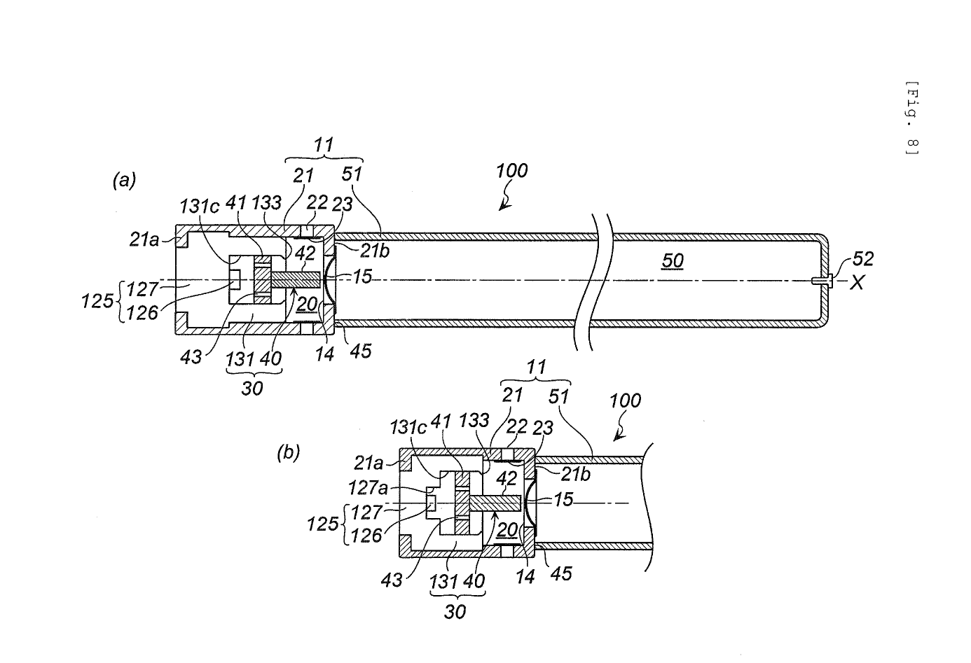

In the circumferential surface 45 of the rod 42 of the rupturing portion 40 depicted in (a) and (b) in FIG. 7, a circumferential surface 45a on the side of the base plate 41 is a round column, and a circumferential surface 45b on the side of the tip surface 46 is a regular hexagonal column.

In (a) and (b) in FIG. 7, the adjustment is made such that the outer diameter of the circumferential surface 45b of the regular hexagonal column is larger than the outer diameter of the circumferential surface 45a of the round column. Such dimensional relationship is preferred in order to increase the rupturing ability for the closing member 15.

The tip surface 46 of the rod 42 in (a) and (b) in FIG. 7 may be a flat or concave surface.

As depicted in (b) in FIG. 7, the plurality of (four in (b) in FIG. 7) through holes 43 are formed equidistantly in the circumferential direction around the tip surface 46, when viewed from the tip surface 46 of the rod 42.

The four through holes 43 depicted in (b) in FIG. 7 are exactly opposite the closing member 15 in the X-axis direction of the cylindrical housing 11, and no other member is disposed on the imaginary axial lines connecting the closing member 15 with the centers of the four through holes 43.

The combustion product discharged from two (two in the horizontal direction in the drawing) among the four through holes 43 advances forward without colliding with a step surface 45c present between the circumferential surface 45a and the circumferential surface 45b of the rod 42 and collides with the closing member 15. Part of the combustion product released from the other two (two in the longitudinal direction in the drawing) through holes collides with the step surface 45c, but most of the combustion product advances forward and collides with the closing member 15.

As depicted in FIG. 4, in the breaking device 30, the rupturing portion 40 is assembled such that a circumferential surface 41c of the base plate 41 abuts against an inner circumferential surface 31c of the cylindrical guide portion 31.

In order to prevent the rupturing portion 40 from moving towards the closing member 15 before actuation and enable the movement towards the closing member 15 at the time of actuation, preferably, a shallow protrusion 36 such as depicted in FIG. 4, is formed on the inner circumferential surface 31c of the cylindrical guide portion 31 and the second surface 41b of the base plate 41 abuts against the protrusion 36.

Further, instead of the protrusion 36, a pin can be used that is fixed to the inner circumferential surface 31c such as to prevent the movement of the rupturing portion 40 towards the closing member 15 before the actuation and to be broken easily and enable the movement of the rupturing portion 40 towards the closing member 15 at the time of actuation.

The inner diameter of the inward annular surface portion 33 of the cylindrical guide portion 31 is adjusted to be smaller than the outer diameter of the base plate 41 in order to function as a stopper that restricts the movement of the rupturing portion 40.

In the gas generator 10 depicted in FIG. 1, the central axes of the igniter 25, the cylindrical guide portion 31 and the rod 42 of the rupturing portion 40 and the center of the closing member 15 coincide with the central axis X of the cylindrical housing 11 (the ignition device chamber housing 21 and the pressurized gas chamber housing 51).

The plurality of through holes 43 of the base plate 41 of the rupturing portion 40 exactly oppose the closing member 15 in the X-axis direction of the cylindrical housing 11, and no other member is disposed on the imaginary axial lines connecting the closing member 15 with all of the plurality of through holes 43.

Therefore, where the area of the through holes 43 in (b) in FIG. 5 is extended, as is, in the X-axis direction (that is, when it is assumed that round columns having a bottom surface whose area is the same as an area of the through hole 43 are extended in the X-axis direction), and where the range of the through holes 43 in (b) in FIG. 7 is extended, as is, in the X-axis direction (that is, when it is assumed that round columns having a bottom surface whose area is the same as an area of the through hole 43 are extended in the X-axis direction), the extended round columns do not come into contact with any other member before abutting against the closing member 15.

The operation of the gas generator 10 depicted in FIG. 1 when it is used in an airbag apparatus for an automobile will be explained hereinbelow.

The rupturing portion 40 such as depicted in (a) and (b) in FIG. 5 is used in the gas generator 10 depicted in FIG. 1. The tip surface 46 of the rod 42 is a flat surface.

When the igniter 25 is actuated, a high-temperature combustion product is generated and pushes the first surface (the pressure-receiving surface) 41a of the base plate 41 of the rupturing portion disposed inside the cylindrical guide portion 31 in the X-axis direction. At this time, part of the combustion product passes through the plurality of through holes 43 of the base plate 41, advances forward, and collides with the closing member 15, thereby transferring heat to the closing member.

In this case, since no other member is present between the through holes 43 and the closing member 15, the high-temperature combustion product after passing through the plurality of through holes 43 collides, without interference, with the closing member 15.

Where the through holes 43 are closed with a sealing tape from the first surface 41a, the pressure is accumulated till the sealing tape is ruptured, and the through holes 43 are thereafter opened. Therefore, the pressure in the space defined by the cylindrical guide portion 31 and the base plate 41 rises rapidly and the amount of the combustion product generated per unit time increases. As a result, a large amount of heat is transferred at once to the closing member 15, which is preferable. When a gas generating agent is used together with the igniter 25, even a larger amount of heat is transferred to the closing member 15.

The rupturing portion 40 then moves in the X-axis direction, the tip surface (the polygonal tip surface) 46 of the rod 42 collides with the central portion of the closing member 15, the closing member 15 ruptures from the central portion, and the gas outlet 14 is opened.

The combustion product heats and applies a pressure to the closing member 15, which facilitates the rupturing by the rod 42 and the deformation such that the centrally ruptured closing member 15 bends toward the ignition device chamber 20. Thereby, a large opening area of the closing member is ensured. As a result, even though the rod 42 is present in the vicinity of the gas outlet 14, the gas flow is not impeded.

At this time, the second surface 41b of the base plate 41 collides with the inward annular surface portion 33 of the cylindrical guide portion 31, thereby restricting further movement.

Further, where the combustion product generated from the igniter 25 remains between the igniter 25 and the first surface 41a of the base plate 41 when the second surface 41b of the base plate 41 collides with the inward annular surface portion 33, the remaining combustion product is released from the release hole 34.

Thus, the gas outlet 14 is opened by a combined action of the rupturing portion 40 (the base plate 41 and the rod 42) and the combustion product after passing through the through holes 43 of the base plate 41, and the gas discharge path extending from the pressurized gas chamber 51 to the gas discharge port 22 is released.

The airbag is then inflated by the gas discharged from the gas discharge port 22.

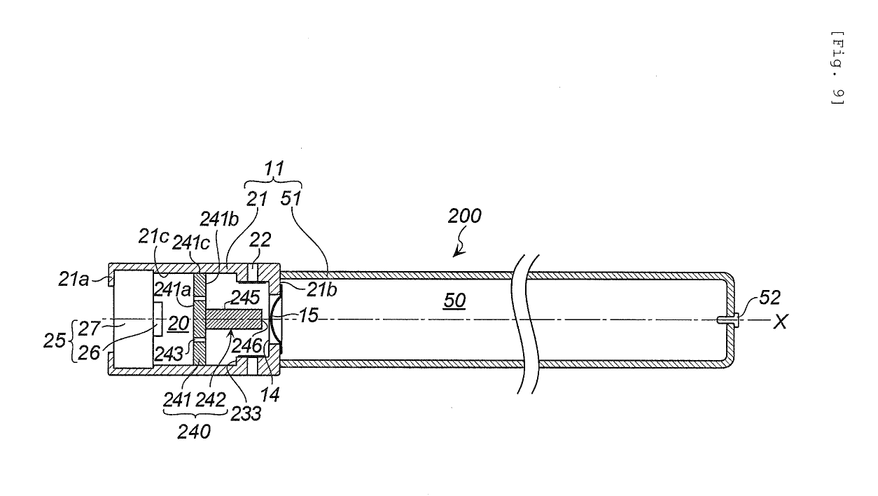

### (2) Gas Generator Depicted in FIG. 8

A gas generator 100 depicted in (a) and (b) in FIG. 8 is the same as the gas generator 10 depicted in FIG. 1, except that a cylindrical guide portion of the breaking device is different.

In (a) and (b) in FIG. 8, components denoted with the reference numerals same as in FIG. 1 are identical to the components in FIG. 1. The gas generator 100 depicted in (a) and (b) in FIG. 8 also can use a combination of an igniter and a gas generating agent as an ignition device.

The breaking device 30 depicted in (a) in FIG. 8 includes the rupturing portion 40 same as that depicted in FIG. 1 and a cylindrical guide portion 131 which is different from that depicted in FIG. 1.

The cylindrical guide portion 131 depicted in (a) in FIG. 8 extends from a surface of an igniter collar 127, which faces an interior of the ignition device chamber 20, and is open on a side of the closing member 15. Therefore, the cylindrical guide portion has a cylindrical shape closed on a side of the igniter collar 127 (a cup-like shape having the igniter collar 127 as a bottom surface).

The cylindrical guide portion 131 has an inward annular surface portion 133 formed inwardly at an opening, and the inner diameter of the inward annular surface portion 133 is adjusted to be smaller than the outer diameter of the base plate 41 of the rupturing portion 40.

Before the rupturing portion 40 is mounted, the inward annular surface portion 133 is an annular wall protruding in the same axial direction as the cylindrical guide portion 131, and the annular wall is bent inward after the rupturing portion 40 is inserted into the cylindrical guide portion 131.

The rupturing portion 40 is disposed in the cylindrical guide portion 131 in a state such that the circumferential surface of the base plate 41 abuts against the inner wall surface 131c of the cylindrical guide portion 131.

In order to prevent the rupturing portion 40 from moving in the X-axis direction inside the cylindrical guide portion 131 before actuation, the shallow protrusion 36 such as depicted in FIG. 4, or something like the pin functioning in a similar manner can be formed on the inner wall surface 131c of the cylindrical guide portion 131.

The gas generator 100 depicted in (b) in FIG. 8 has substantially the same structure as that of the gas generator 100 depicted in (a) in FIG. 8.

The only difference therebetween is that in the gas generator 100 depicted in (b) in FIG. 8, an igniter main body 126 protrudes from the igniter collar 127, whereas in the gas generator 100 depicted in (b) in FIG. 8, the ignition portion of the igniter main body 126 is positioned in a concave portion 127a of the igniter collar 127.

### (3) Gas Generator Depicted in FIG. 9

A gas generator 200 depicted in FIG. 9 is the same as the gas generator 10 depicted in FIG. 1, except that the shapes of the breaking device and the ignition device chamber housing 21 are partially different.

In the gas generator 200 depicted in FIG. 9, a rupturing portion 240 is used which corresponds to the rupturing portion 40 used in the breaking device 30 of the gas generator 10 depicted in FIG. 1, but the cylindrical guide portion 31 used in the breaking device 30 of the gas generator 10 depicted in FIG. 1 is not used.

In FIG. 9, components denoted with the reference numerals same as in FIG. 1 are identical to the components in FIG. 1. The gas generator 200 depicted in FIG. 9 also can use a combination of an igniter and a gas generating agent as an ignition device.

The rupturing portion 240 has the same structure and shape as the rupturing portion 40 in the gas generator 10 depicted in FIG. 1, but is larger than the rupturing portion 40.

The rupturing portion 240 has a base plate 241 and a rod 242 extending from a second surface 241b of the base plate 241.

The base plate 241 has a plurality of through holes 243 passing through from a first surface (a pressure-receiving surface) 241a to a second surface 241b on the reverse side.

The rupturing portion 240 is disposed in a state in which a circumferential surface 241c of the base plate abuts against an inner wall surface 21c of the ignition device chamber housing 21, and the ignition device chamber housing 21 functions in the same manner as the cylindrical guide portion 31 in the gas generator 10 depicted in FIG. 1.

A step portion 233 is formed on the inner wall surface 21c of the ignition device chamber housing 21 near the gas discharge port 22. The step portion 233 corresponds to the inward annular surface portion 33 of the cylindrical guide portion 31 in the gas generator 10 depicted in FIG. 1, and functions as a stopper that restricts the movement of the rupturing portion 240.

The gas generator 200 depicted in FIG. 9 operates in the same manner as the gas generator 10 depicted in FIG. 1, to inflate an airbag.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator, comprising:
a cylindrical housing including therein,
an ignition device chamber which accommodates an igniter and is provided with a gas discharge port, and
a pressurized gas chamber filled with a pressurized gas;
a closing member closing between the ignition device chamber and the pressurized gas chamber;
a breaking device for the closing member provided within the ignition device chamber, along with the igniter which has an igniter main body and an igniter collar,
the igniter being fixed to an end portion of the cylindrical housing on a side of the ignition device chamber,
the breaking device for the closing member having,
a cylindrical guide portion formed inside the ignition device chamber, and
a rupturing portion disposed to be movable in an axial direction inside the cylindrical guide portion,
the cylindrical guide portion being disposed such that,
a first end portion thereof encloses an ignition portion of the igniter main body and is fixed to the igniter collar or an inner wall surface of the cylindrical housing, and
a second end portion thereof on an opposite side to the first end portion is positioned on a side of the closing member,
the rupturing portion having,
a base plate including a pressure-receiving surface which receives a combustion product from the igniter, and
a rod extending in the axial direction from a surface of the base plate on the reverse side of the pressure-receiving surface,
the base plate provided with a plurality of through holes passing through in a thickness direction thereof,
at least a tip portion of the rod being a polygonal column,
before actuation, the base plate being disposed to abut against an inner circumferential surface of the cylindrical guide portion, and
at time of actuation, the base plate and the rod being moved inside the guide portion by the combustion product generated due to the igniter, and the tip portion of the rod colliding with and opening the closing member, thereby opening a gas discharge path extending from the pressurized gas chamber to the gas discharge port.

2. The gas generator according to claim 1, wherein the cylindrical guide portion has an inward annular surface portion which is formed inwardly at an opening of the second end portion, and
an inner diameter of the inward annular surface portion is adjusted to be smaller than an outer diameter of the base plate of the rupturing portion.

3. The gas generator according to claim 1, wherein the cylindrical guide portion has a plurality of release holes provided in the circumferential wall surface thereof.

4. A gas generator, comprising:
a cylindrical housing including therein,
an ignition device chamber which accommodates an igniter and is provided with a gas discharge port, and
a pressurized gas chamber filled with a pressurized gas;
a closing member closing between the ignition device chamber and the pressurized gas chamber;
a breaking device for the closing member provided within the ignition device chamber, along with the igniter which has an igniter main body and an igniter collar,
the igniter being fixed to an end portion of the cylindrical housing on a side of the ignition device chamber,
the breaking device for the closing member having,
a cylindrical guide portion formed inside the ignition device chamber, and
a rupturing portion disposed to be movable in an axial direction inside the cylindrical guide portion,
the cylindrical guide portion extending from a surface of the igniter collar that faces an interior of the ignition device chamber and enclosing the ignition portion of the igniter main body, and being open on a side of the closing member,
the rupturing portion having,
a base plate including a pressure-receiving surface which receives a combustion product from the igniter, and
a rod extending in the axial direction from a surface of the base plate on the reverse side of the pressure-receiving surface,
the base plate provided with a plurality of through holes passing through in a thickness direction thereof,
at least a tip portion of the rod being a polygonal column,
before actuation, the base plate being disposed to abut against an inner circumferential surface of the cylindrical guide portion, and
at time of actuation, the base plate and the rod being moved inside the cylindrical guide portion by the combustion product generated due to the igniter, and the tip portion of the rod colliding with and opening the closing member, thereby opening a gas discharge path extending from the pressurized gas chamber to the gas discharge port.

5. The gas generator according to claim 4, wherein the cylindrical guide portion has an inward annular surface portion which is formed inwardly at an opening thereof, and
an inner diameter of the inward annular surface portion is adjusted to be smaller than an outer diameter of the base plate in rupturing portion.

6. A gas generator, comprising:
a cylindrical housing including therein,
an ignition device chamber which accommodates an igniter and is provided with a gas discharge port, and
a pressurized gas chamber filled with a pressurized gas;
a closing member closing between the ignition device chamber and the pressurized gas chamber;
a breaking device for the closing member provided within the ignition device chamber, along with the igniter which has an igniter main body and an igniter collar,
the igniter being fixed to an end portion of the cylindrical housing on a side of the ignition device chamber,
the breaking device for the closing member being a rupturing portion disposed to be movable in an axial direction inside the ignition device chamber,
the rupturing portion having,
a base plate including a pressure-receiving surface that receives a combustion product from the igniter, and
a rod extending in the axial direction from a surface of the base plate on the reverse side of the pressure-receiving surface,
the base plate provided with a plurality of through holes passing through in a thickness direction thereof,
at least a tip portion of the rod being a polygonal column,
before actuation, the base plate of the rupturing portion being disposed to abut against an inner wall surface of the ignition device chamber, and
at time of actuation, the base plate and the rod being moved inside the ignition device chamber by the combustion product generated due to the igniter, and the tip portion of the rod colliding with and opening the closing member, thereby opening a gas discharge path extending from the pressurized gas chamber to the gas discharge port.

7. The gas generator according to claim 1, wherein
the plurality of through holes of the base plate in the rupturing portion are formed equidistantly in a circumferential direction around the rod,
the plurality of through holes are exactly opposite the closing member in the axial direction of the cylindrical housing, and
no other member is disposed on the imaginary axial line connecting the closing member with at least any one of centers of the plurality of the through holes.

8. The gas generator according to claim 1, wherein
the rod of the rupturing portion has a flat tip surface.

9. The gas generator according to claim 1, wherein
the rod of the rupturing portion has a concave tip surface.

10. The gas generator according to claim 1, wherein
a cross-sectional shape of a portion at the polygonal column in the rod is selected from triangular, quadrangular, pentagonal, and hexagonal shapes.

11. The gas generator according to claim 1, wherein
the plurality of through holes formed in the base plate in the rupturing portion is closed with a sealing member attached from the pressure-receiving surface.

12. The gas generator according to claim 4, wherein
the plurality of through holes of the base plate in the rupturing portion are formed equidistantly in a circumferential direction around the rod,
the plurality of through holes are exactly opposite the closing member in the axial direction of the cylindrical housing, and
no other member is disposed on the imaginary axial line connecting the closing member with at least any one of centers of the plurality of the through holes.

13. The gas generator according to claim 4, wherein
the rod of the rupturing portion has a flat tip surface.

14. The gas generator according to claim 4, wherein
the rod of the rupturing portion has a concave tip surface.

15. The gas generator according to claim 6, wherein
the plurality of through holes of the base plate in the rupturing portion are formed equidistantly in a circumferential direction around the rod,
the plurality of through holes are exactly opposite the closing member in the axial direction of the cylindrical housing, and
no other member is disposed on the imaginary axial line connecting the closing member with at least any one of centers of the plurality of the through holes.

16. The gas generator according to claim 6, wherein
the rod of the rupturing portion has a flat tip surface.

17. The gas generator according to claim 6, wherein
the rod of the rupturing portion has a concave tip surface.
